(19) United States
(12) Patent Application Publication
(10) Pub. No.: US 2003/0149720 A1
(43) Pub. Date: Aug. 7, 2003

(54) System and method for accelerating internet access

(76) Inventor: Leonid Goldstein, Costa Mesa, CA (US)

Correspondence Address: COUDERT BROTHERS LLP, 333 SOUTH HOPE STREET, 23RD FLOOR, LOS ANGELES, CA, 90071, US

(21) Appl. No.: 10/071,947

(22) Filed: Feb. 6, 2002

(51) Int. Cl. G06F 15/16

(52) U.S. Cl. 709/202

(57) ABSTRACT

A system and method for communication in a wide area network comprises a client, first proxy, second proxy and one or more server computers each having a data processing means, data storing means, and operating system and all interconnected via a wide area network such as the Internet. The first proxy computer is enabled for communication with the server computer using an application layer protocol. The second proxy computer is placed local to the client computer and is enabled by a special optimizing protocol for communication with the first proxy computer. The second proxy computer is enabled for communication with the client computer using the application layer protocol.

### BACKGROUND OF THE INVENTION

1. Field of the Invention

This invention relates generally to communication over a wide area network and more particularly to Internet access.

2. Description of Related Art

The prior art, as shown in FIGS. 1 and 2, teaches the use of proxy computers for enhancing access speed over a wide area network such as the Internet. FIG. 1 shows that a first remote proxy computer may be used for enhanced access speed to a remote server computer. FIG. 2 shows that it is know to place the first proxy computer locally to the client computer for improvements in access speed. However, the prior art does not teach the present operational elements, configuration and method for superior access speed. The present invention fulfills this need and provides further related advantages as described in the following summary.

Specific references which describe the present state of the prior art are as follows:

Pepe et al., U.S. Pat. No. 5,673,322 describes an interface between a protected computer or computer network and the World Wide Web (WWW). The interface comprises a split proxy system that encapsulates TCP/IP transmissions into a script transmission, which is not subject to problems in high latency systems, thereby greatly improving WWW access, via a wireless modem or other low-bandwidth communications network. The split proxy interface also provides compression, encryption and filtering capabilities and allows receipt of unsolicited transmissions from the service provider for such purposes as automatically updating or configuring WWW access software.

Kikinis, U.S. Pat. No. 5,727,159 describes a system wherein relatively low-end computers, such as portable, battery-powered computers ordinarily incapable of Internet browsing functions may be used to browse the Internet. The enhanced computing ability for such portables is provided by a unique arrangement having a Proxy-Server with adequate computing power for all World Wide Web (WWW) browsing and downloading functions, and further capable of transposing downloaded files to alternative, low-information-density form suitable for rapid processing and display by connected portable and other low-end computers. In some embodiments the data link from the connected low-end units is a TCP/IP pipe, supporting TCP/IP protocol, but not the many sophisticated extensions usually associated with TCP/IP. In embodiments wherein battery-powered units are used, connected to the Proxy-Server, battery life is exhibited far beyond what would be expected for a battery-powered computer with computing power for browsing the Internet directly.

Bhide et al, U.S. Pat. No. 5,852,717 describes a system and method of increasing the performance of computer networks, especially networks connecting users to the Web. Performance is increased by reducing the latency the client experiences between sending a request to the server and receiving a response. A connection cache may be maintained by an agent on the network access equipment to more quickly respond to request for network connections to the server. Additionally, the agent may maintain a cache of information to more quickly respond to requests to get an object if it has been modified. These enhancements and other described herein may be implemented singly or in conjunction to reduce the latency involved in sending the requests to the server by saving round-trip times between computer network components.

Parzych, U.S. Pat. No. 6,115,384 describes a gateway architecture for data communication over bandwidth-constrained and charge-by-use networks using a C.sub.—Gate application located between a client application and a bandwidth-constrained network, and an S.sub.—Gate application located between the bandwidth-constrained network and an Internet server, to send and receive data in an efficient manner across the bandwidth-constrained network by converting the native protocols of the client application and the Internet server to a bandwidth-efficient protocol. The C.sub.—Gate application and S.sub.—Gate application also act to reconvert data packets from the bandwidth-efficient protocol back to the native transport protocols for data communication to the Internet server and the client application.

### SUMMARY OF THE INVENTION

The present invention teaches certain benefits in construction and use which give rise to the objectives described below.

A system and method for communication in a wide area network comprises a client, first proxy, second proxy and one or more server computers each having a data processing means, data storing means, and operating system and all interconnected via a wide area network such as the Internet. The first proxy computer is enabled for communication with the server computer using an application layer protocol. The second proxy computer is placed local to the client computer and is enabled by a special optimizing protocol for communication with the first proxy computer. The second proxy computer is enabled for communication with the client computer using the application layer protocol.

A primary objective of the present invention is to provide an apparatus and method of use of such apparatus that provides advantages not taught by the prior art.

Another objective is to provide such an invention capable of increasing access speed by a client computer to a server data over a wide area network.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIG. 1 is a block diagram of the prior art communication system;

FIG. 2 is a block diagram of a further prior art communication system;

FIG. 3 is a block diagram showing a general configuration of a communication system of the present invention;

FIG. 4 is a block diagram of a preferred embodiment thereof;

FIG. 5 is an operational diagram thereof; and

FIG. 6 is a block diagram defining a method thereof.

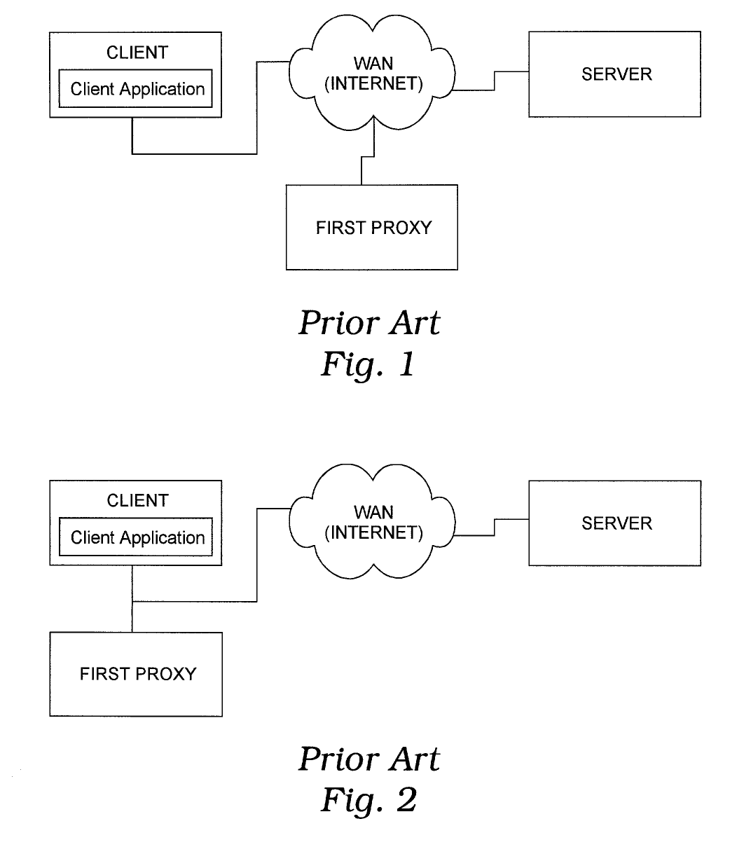

### DETAILED DESCRIPTION OF THE INVENTION

The above described drawing figures illustrate the invention in at least one of its preferred embodiments, which is further defined in detail in the following description.

In one embodiment the present invention teaches a wide area network (WAN) system comprising: a plurality of computers enabled for mutual communication using an optimizing protocol; a first one of the computers enabled for acting as a proxy for a second one of the computers using an application layer protocol; and the second one of the computers acting as a proxy for at least a third one of the computers using the application layer protocol, wherein the first one of the computers is enabled for communication with the fourth one of computers using the application layer protocol; the second one of the computers being further enabled for selecting between the first one and fourth one of the computers, for directing a request from one of the third ones of the computers.

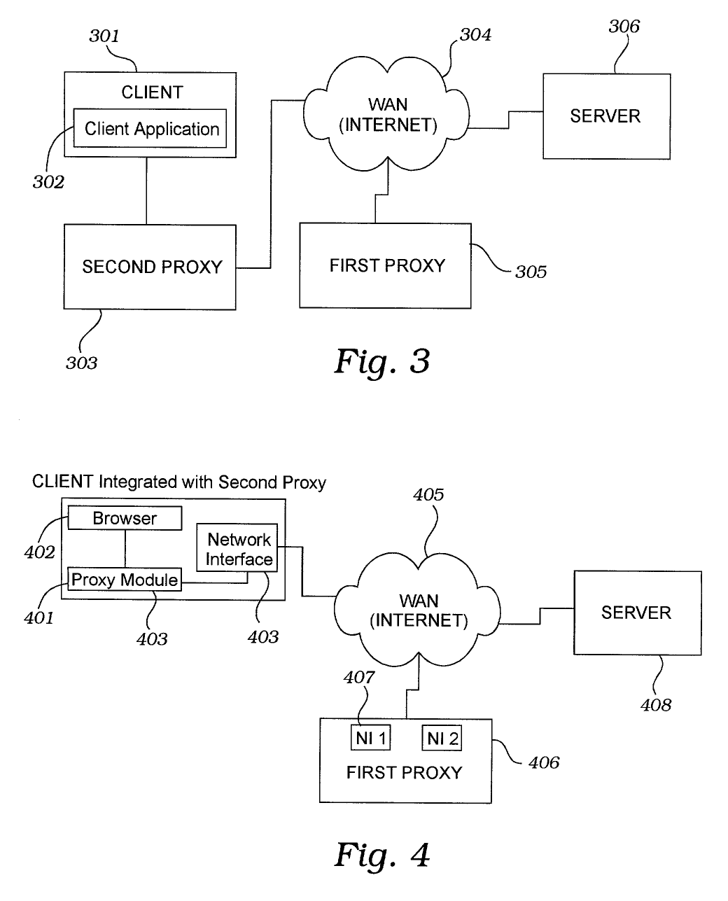

The present invention, as shown in FIG. 3, is a system for improved communication speed over a WAN 304 such as the Internet, which comprises several computers including a client computer 301 having a client data processing means, a client data storing means, a client operating system, and a client application instruction set 302; a first proxy computer 305 having a first proxy data processing means, a first proxy data storing means, and a first proxy operating system; a second proxy computer 303 having a second proxy data processing means, a second proxy data storing means, and a second proxy operating system; a server computer 306 having a server data processing means, a server data storing means, and a server operating system; the client, first proxy, second proxy and server computers interconnected through a wide area network such as the Internet. The first proxy computer is enabled for communication with the server computer using an application layer protocol. The second proxy computer is preferably placed local to the client computer and is enabled by a special optimizing protocol for communication with the first proxy computer. The second proxy computer is enabled for communication with the client computer using the application layer protocol. The second proxy computer further is enabled for selecting between the server computer and the first proxy computer, for directing a request from the client computer.

Preferably, the application layer protocol is HTTP and the client application is a browser. Preferably, the first and second proxy computers have means, well known in the art, for mutually compatible data compression and restoration.

The system operational method comprises the steps of: configuring the client computer, the first proxy computer, the second proxy computer, and the server computer, each having the data processing means, the data storing means, and an operating system; interconnecting said computers for communication through the wide area network; enabling the first proxy computer for communication with the server computer using an application layer protocol; placing the second proxy computer local to the client computer; enabling the first proxy computer and the second proxy computer for communication by the special optimizing protocol; and enabling the second proxy computer for communication with the client computer using the application layer protocol.

The method further comprises the step of enabling the second proxy computer for communication with the server computer using the application layer protocol. The second proxy computer further is enabled for selecting between the server computer and the first proxy computer, for directing a request from the client computer.

The method further comprises the step of enabling the application layer protocol in HTTP wherein the client application is adapted for browsing, and the step of enabling the first and second proxy computers for operating with mutually compatible data compression.

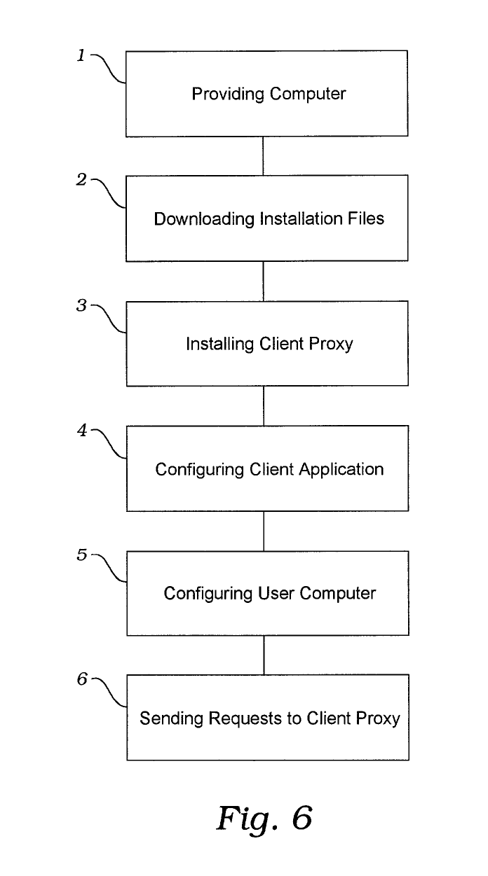

Referring to FIG. 6, The method may also deploy a two proxy system comprising the steps of: providing at least one user computer (step 1) having the data processing means, the data storing means, an operating system and the network connection directly to an Internet backbone, and at least one proxy computer; downloading installation files from the web site to the memory device in the user computer (step 2), and installing the client proxy software from the installation files (step 3); enabling the user computer using downloaded software to configure the client application for sending requests in the application protocol to the client proxy software (step 4); using downloaded software to configure the user computer for operating the client proxy software whenever the client application is operating (step 5); and sending at least one portion of the requests from the application to the first computer system (step 6).

The method further comprises the step of using the downloaded software to assign an access code to the client computer, the access code enabling authorized use of the first computer by the client computer and further comprises the step of using the downloaded software to assign an access code to the client computer, the access code enabling the client proxy software for use by the client application.

Further discussing the present invention, now, we provide enabling details as follows:

FIG. 3 shows the basic system for communication between a client 301 and a server in a wide area network comprising a client computer having CPU, memory, operating system (OS) and a client application 302, a means to communicate with a server over a wide area network 304, using an application layer protocol, a first proxy 305, having CPU, memory, OS, connected to the wide area network using a fast network connection and having means to communicate with a server using the application layer protocol, a second proxy, having CPU, memory, OS, connected to the wide area network close to the client computer and having means to communicate with said first proxy, using a specialized protocol, optimized for the kind of connection between the first proxy and the second proxy, the second proxy further having means to communicate with the client application using the same application layer protocol.

FIG. 4 shows a further enhancement of the preferred embodiment, where the client computer 401 is a PC, having CPU and memory, running any type of windows operating system and a browser 402, such as Internet Explorer 5.5. It is connected to the Internet 405 through a modem connection and uses a TCP/IP stack, which is a part of the OS, as a software for Internet connectivity. The first proxy is a server computer 406, having CPU, memory, Linux or windows type server as an OS, and has a high speed connection 407, such as DS3, to some major Internet backbone. The application protocol is HTTP, which has provisions for the use of proxies. The second proxy 403 is on a network, close to the client. In the preferred embodiment, the second proxy 403 is integrated with the client and comprises software that runs on the client computer. The operation of this software will be described below. We will call this software a Proxy Module. The browser is configured in such a way, that it sends all of its requests to the second proxy (Proxy Module). The Proxy Module is active at all times that the browser is active. The best way to achieve this is to start it every time the OS starts, and to let it run until the OS shuts down. Also, there is a multitude of web servers 408, connected to the Internet.

The configuration is preferably automatic in order to allow non-technical end-users to use this system. The following describes how this is achieved assuming that the first proxy is already deployed. A provider deploys the required software on its web site in the form of a file that allows self installation, such as Microsoft's “cab file.” The client downloads this file, unpacks and installs the Proxy Module on its hard drive. A part of the downloaded software is a script or a code, which changes the system configuration to start this Proxy Module each time the OS starts. That can be achieved by placing a shortcut to its executable file into a startup folder. Therefore, the browser settings are changed to redirect all HTTP requests to this Proxy Module. This can be done by enabling a proxy and inputting the proxy IP address as 127.0.0.1. Thus the Proxy Module is started. Finally, the Proxy Module is supplied with the IP address of the first proxy. For this purpose, the host name of the first proxy can be hard coded in the Proxy Module, and the Proxy Module will resolve it dynamically to the IP address, using DNS.

In many environments, it is necessary to allow use of the system only by authorized users. For this purpose, an access code is assigned to the client system at the time of the installation or prior to the first run. This access code can be assigned automatically or manually by a user. The Proxy Module will include this access code in every request that it sends to the first proxy. The first proxy will verify whether the access code is valid, and respond only to the requests with a valid access code. In another embodiment, the proxy module periodically sends the access code for the verification with a specially established server. The specially established server responds with “positive” or “negative”, and may supply additional customer specific configuration information.

The main advantage of a disclosed system with two proxies is that it allows to implement a protocol optimized for a special kind of connection between them. Additionally, it allows the second proxy to decide, whether to send a request from the browser to the first proxy or directly to the web server. Also, there may be a plurality of the first proxies, varying by their type and location. Different first proxies can handle different types of data (such as images and text) or apply different transformations to it. The second proxy can select which first proxy to use, based on such factors as location of the destination server, type of data, load on the different first proxies and so on.

The ability of the second proxy to decide, how to route the request from the browser is very important. The optimized protocol between the first proxy and the second proxy will typically yield a speed increase, but not for all the requests. Overhead from routing these requests through the first proxy, instead of sending them directly to the web server, may diminish or even reverse any speed advantages through the use of the optimized protocol. These are some of the ways for the second proxy to decide on routing the browser requests in the preferred embodiment:

1) Using the requested file extension. The second proxy may guess the type of the data in the response by its file extension. For example: a) if the file extension is “html”, “htm”, “asp”, “php”, “css”, then the data in the response is likely to be text, and the request will be routed through a first proxy, supporting text compression; if such a first proxy is unavailable, it should be sent directly to the original server; b) if the file extension is “jpg” or “jpeg”, then the data in the response is likely to be JPEG images, and the request will be routed through a first proxy, supporting enhanced compression of JPEG images; if such a first proxy is unavailable, it should be sent directly to the original server; c) if the file extension is “gif”, then the data in the response is likely to be GIF image, and the request should be routed through a first proxy, supporting enhanced compression of GIF images; if such a first proxy is unavailable, it should be sent directly to the original server.

2) Using an HTTP “Accept” header. This is similar to the previous paragraph, but the information about the data in the response is derived from the HTTP “Accept” header.

3) Using HTTP conditional headers, such as “If-Non-Match”, “If-Modified-Since”. Such headers mean there is a high probability of a response with no data, and the request will be routed to a first proxy, that supports optimization of a combination “request—response with no data”; if such a first proxy is unavailable, it will be sent directly to the original server.

4) Historical information about the performance of different original servers may be kept. If the reaction time and/or throughput of a particular server exceeds a preset configurable value, the request will be sent directly to the server; otherwise it will be routed through a first proxy.

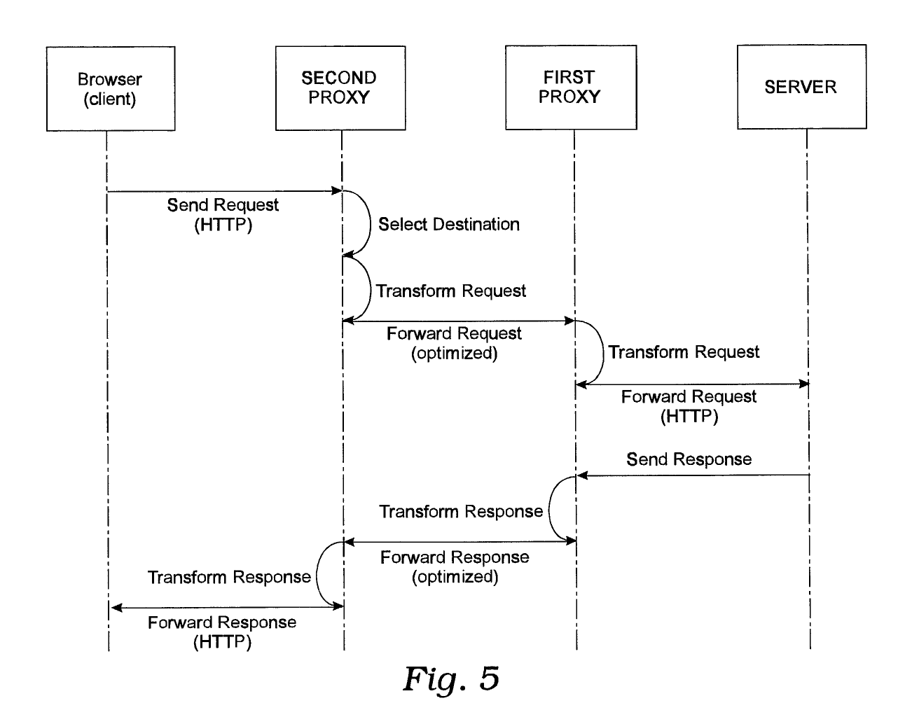

The system operates as shown in FIG. 5 and as follows. The browser sends a data request to the second proxy (Proxy Module in the preferred embodiment). The second proxy decides whether to send the request directly to the destination server, or to a first proxy. Let us assume that it decides to send the request to the first proxy. The second proxy applies transformations to the request, transforming it to the optimized protocol, and sends the transformed request to the first proxy. Combining a number of requests in HTTP to one request in the optimized protocol is a special case of such a transformation. The second proxy now sends the transformed request to the first proxy. The first proxy transforms the request back to HTTP and sends it to the destination server. The server sends the reply to the first proxy. The first proxy transforms a reply to the optimized protocol and sends it back to the second proxy. The second proxy transforms the reply to HTTP and sends it back to the browser.

In a preferred embodiment, the first proxy has means for compression of some or all of the responses, and the second proxy has a compatible means for decompression of the compressed responses. GZIP is a preferred format for compression of text data, as an example. PNG is a preferred format for compression of palettized images. In operation, when the first proxy receives a data response, if it contains text, it uses GZIP to compress it. If it contains a palettized images, it uses PNG to compress it. GZIP is described in RFC 1952. PNG is described in RFC 2083. If a palettized image arrives compressed in a different format, it is uncompressed prior to the compression according to PNG.

In another preferred embodiment, the second proxy has means for compression of some or all of the requests, and the first proxy has compatible means for decompression of the compressed requests. GZIP is a preferred format for compression of the requests.

As a special case of an optimized protocol, the system can implement HTTP 1.1 features more thoroughly than they are usually implemented in direct communication between the browser and the server.

While the invention has been described with reference to at least one preferred embodiment, it is to be clearly understood by those skilled in the art that the invention is not limited thereto. Rather, the scope of the invention is to be interpreted only in conjunction with the appended claims.

What is claimed is:

1. A WAN system comprising: a plurality of computers enabled for mutual communication using an optimizing protocol; a first one of the computers enabled for acting as a proxy for a second one of the computers using an application layer protocol; and the second one of the computers acting as a proxy for at least a third one of the computers using the application layer protocol, wherein the first one of the computers is enabled for communication with the fourth one of computers using the application layer protocol; the second one of the computers being further enabled for selecting between the first one and the fourth one of the computers, for directing a request from one of the third one of the computers.

2. The system of claim 1 wherein the application layer protocol is HTTP and the second and third computers are one and the same computer.

3. The system of claim 1 wherein the first and second ones of the computers each employ a means for compatible data compression.

4. A method for communication over a wide area network comprising the steps of: configuring a client computer, a first proxy computer, a second proxy computer, and a server computer, each having a data processing means, a data storing means, and an operating system; interconnecting the computers for communication through a wide area network; enabling the first proxy computer for communication with the server computer using an application layer protocol; placing the second proxy computer local to the client computer; enabling the first proxy computer and the second proxy computer for communication by a special optimizing protocol; and enabling the second proxy computer for communication with the client computer using the application layer protocol, and further comprising the step of enabling the second proxy computer for communication with the server computer using the application layer protocol; the second proxy computer further enabled for selecting between the server computer and the first proxy computer, for directing a request from the client computer.

5. The method of claim 4 further comprising the step of enabling the application layer protocol in HTTP and wherein the client application is adapted for browsing.

6. The method of claim 4 further comprising the step of enabling the first and second proxy computers for operating with mutually compatible data compression.

7. The method of claim 4 further comprising the step of enabling the application layer protocol in HTTP and wherein the client application is adapted for browsing.

8. A method of deploying a two proxy system comprising the steps of: providing at least one user computer communicating with Internet serving computers using an application layer protocol, and at least one proxy computer; downloading installation files from a web site to a memory device in a user computer, and installing the client proxy software from the installation files; enabling the user computer, using downloaded software, to configure the client application for sending requests in the application protocol to the client proxy software; using downloaded software to configure the user computer for operating the client proxy software whenever the client application is operating; and sending at least one portion of the requests from the application to the first computer system.

9. A method of deploying a two proxy system comprising the steps of:
a. providing a plurality of computers interconnected via WAN
b. transferring installation files from one of the computers to another of the computers.
c. enabling the another of the computers to act as a proxy for a browser function thereof
d. enabling the another of the computers to use a further computer as a proxy therefor.

10. A method comprising the steps of: providing at least a first computer communicating with a plurality of Internet serving computers using an application layer protocol; downloading installation files from a web site to a memory device in a user computer, and installing the client proxy software from the installation files; enabling the client proxy software for communicating with an application using the application layer protocol; and enabling the user computer using downloaded software to configure the client application for sending requests in the application protocol to the client proxy software, using downloaded software to configure the user computer for operating the client proxy software whenever the client application is operating; and sending at least one portion of the requests from the application to the first computer.
